(19) United States
(12) Patent Application Publication
(10) Pub. No.: US 2012/0052893 A1
(43) Pub. Date: Mar. 1, 2012

(54) RADIO COMMUNICATION SYSTEM, CONTROL STATION, AND CONTROL METHOD

(75) Inventors: Kazuaki Ando, Kawasaki (JP); Naoyuki Saitou, Kawasaki (JP)

(73) Assignee: FUJITSU LIMITED, Kawasaki-shi (JP)

(21) Appl. No.: 13/212,414

(22) Filed: Aug. 18, 2011

(30) Foreign Application Priority Data
Aug. 25, 2010 (JP) 2010-188184

(51) Int. Cl. H04W 16/02

(52) U.S. Cl. 455/507

(57) ABSTRACT

A radio communication system includes a plurality of radio base stations, and a control station which controls the plurality of radio base stations, wherein the control station comprises a controller which determines a peripheral base station, from among a plurality of peripheral base stations, and which adjusts a radio parameter for changing a range of a communication area based on each load of the plurality of peripheral base stations which are adjacent or close to a radio base station to be relieved from among the plurality of radio base stations.

### CROSS-REFERENCE TO RELATED APPLICATION

This application is based upon and claims the benefit of priority of the prior Japanese Patent Application No. 2010-188184, filed on Aug. 25, 2010, the entire contents of which are incorporated herein by reference.

### FIELD

Embodiments discussed herein are related to a control station and a control method for controlling a radio base station, and to a radio communication system that includes the radio base station, the control station, and the like.

### BACKGROUND

In the radio communication system such as a mobile phone system, the control station monitors or controls, for example, a plurality of radio base stations. Each of the plurality of radio base stations performs radio communication with a mobile terminal positioned inside a communication area (for example, a cell or a sector) covered by the plurality of radio base stations.

In the above-described radio communication system, if an error occurs in the radio base station (for example, if an event obstructs an operation, which is normal or stable, or obstructs the operation in the future), the mobile terminal, positioned inside the communication area of the radio base station in which the error occurs, has difficulty maintaining the radio communication or starting another radio communication.

### SUMMARY

According to an aspect of the embodiments discussed herein, a radio communication system includes a plurality of radio base stations, and a control station which controls the plurality of radio base stations, wherein the control station comprises a controller which determines a peripheral base station, from among a plurality of peripheral base stations, and which adjusts a radio parameter for changing a range of a communication area based on each load of the plurality of peripheral base stations which are adjacent or close to a radio base station to be relieved from among the plurality of radio base stations.

Additional objects and advantages of the embodiments will be set forth in part in the description which follows, and in part will be obvious from the description, or may be learned by practice of the embodiments. The object and advantages of the embodiments will be realized and attained by means of the elements and combinations particularly pointed out in the appended claims.

It is to be understood that both the foregoing general description and the following detailed description are exemplary and explanatory and are not restrictive of the embodiments, as claimed.

### BRIEF DESCRIPTION OF DRAWINGS

FIG. 1 is a block diagram illustrating a configuration of a radio communication system according to a first embodiment;

FIG. 2 is a block diagram illustrating function blocks of a monitor control station according to the first embodiment;

FIG. 3 is a block diagram illustrating hardware blocks of the monitor control station according to the first embodiment;

FIG. 4 is a block diagram illustrating function blocks of a radio base station according to the first embodiment;

FIG. 5 is a block diagram illustrating hardware blocks of the radio base station according to the first embodiment;

FIG. 6 is a flowchart illustrating an example of a flow of an operation of the radio communication system according to the first embodiment;

FIG. 7 is a table illustrating an example of a relation between a priority order and a traffic amount;

FIG. 8 is a table illustrating an example of a relation between a control range of a tilt angle and a priority order;

FIG. 9 is a flowchart illustrating an example of a flow of a modified operation in the radio communication system according to the first embodiment;

FIG. 10 is another table illustrating an example of the relation between the priority order and the traffic amount; and

FIG. 11 is another table illustrating an example of the relation between the control range of the tilt angle and the priority order.

### DESCRIPTION OF EMBODIMENTS

Embodiments will be described with reference to the attached diagrams. Hereinafter, a mobile phone system will be described as an example of the radio communication system. The embodiments described below are applicable to various radio communication systems other than the mobile phone system.

(1) Configuration of Radio Communication System

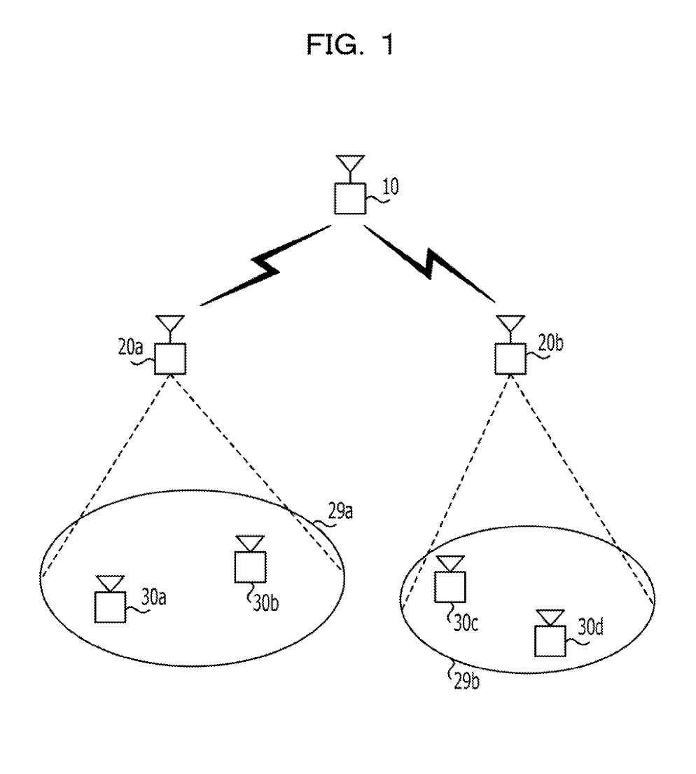

With reference to FIG. 1, a configuration of a radio communication system 1 according to a first embodiment will be described. FIG. 1 is a block diagram illustrating an example of the configuration of the radio communication system 1 according to the first embodiment.

As illustrated in FIG. 1, the radio communication system 1 according to the first embodiment includes a monitor control station 10, a radio base station 20a, a radio base station 20b, a mobile terminal 30a, a mobile terminal 30b, a mobile terminal 30c, and a mobile terminal 30d. The number of the radio base stations 20 and the number of the mobile terminals 30 illustrated in FIG. 1 are examples. The number of the radio base stations 20 and the number of the mobile terminals 30 are not limited to the examples illustrated in FIG. 1. Hereinafter, for the sake of convenience, when the radio base station 20a and the radio base station 20b are described without being distinguishing from each other, the radio base station 20a and the radio base station 20b are referred to as a “radio base station 20.” Similarly, when the mobile terminal 30a and the mobile terminal 30d are described without being distinguished from each other, the mobile terminal 30a and the mobile terminal 30d are referred to as a “mobile terminal 30.”

For example, the monitor control station 10 sets and opens channels for each speech communication of a plurality of radio base stations 20 positioned under the monitor control station 10 and controls handover of the mobile terminal 30 positioned inside a cell 29 (e.g., 29a or 29b) of each of the plurality of radio base stations 20 positioned under the monitor control station 10. FIG. 1 illustrates an example of a case where the radio base station 20a and the radio base station 20b are positioned under the monitor control station 10. The monitor control station 10 performs communication with the plurality of radio base stations 20 positioned under the monitor control station 10 through a wired communication line (for example, a LAN line). Furthermore, the monitor control station 10 may perform the communication with the plurality of radio base stations 20 positioned under the monitor control station 10 through a radio communication line.

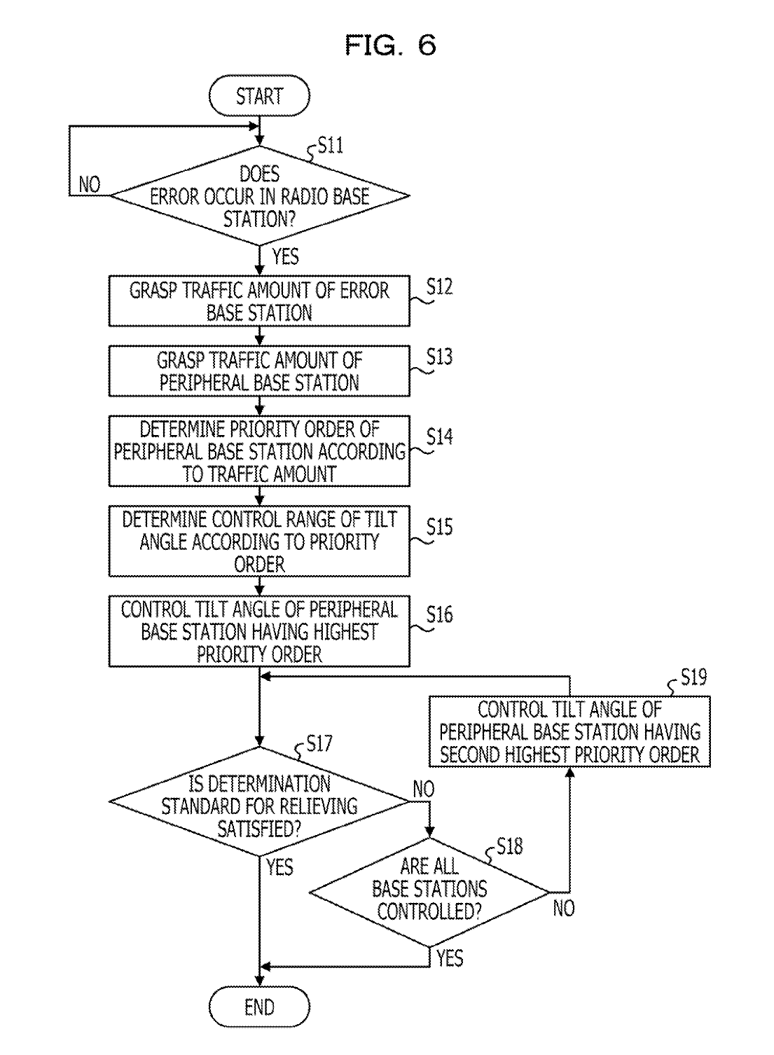

According to the first embodiment, when an error occurs in the radio base station 20, the monitor control station 10 controls the operation of the plurality of radio base stations 20 (hereinafter referred to as a “peripheral base station 20”) positioned in periphery of the radio base station 20 (hereinafter referred to as an “error base station 20”) in which the error occurs. For example, an “error” is an example of an event (for example, a hardware error, operation runaway, or operation suspension) that obstructs the operation, which is normal or stable, of the radio base station 20. Alternatively, the “error” according to the first embodiment is an example of an event (for example, detection or the like of an abnormal value (or a value other than acceptable values) of various parameters indicating an operation state of the radio base station 20) that may obstruct the operation, which is normal or stable, of the radio base station 20. More specifically, the monitor control station 10 controls the operation of the plurality of peripheral base stations 20 so that the cell 29 (for example, a range that is the cell 29 before the error occurs) of the error base station 20 is compensated (that is, relieved or covered) by the plurality of peripheral base stations 20. The control of the peripheral base station 20 by the monitor control station 10 will be described below (see FIG. 6). If the radio base station, positioned in the periphery of the radio base station in which an error occurs, compensates (relieves, in other words) a communication area (for example, a range that is the communication area) of the radio base station in which the error occurs, the radio communication performed by the mobile terminal may be maintained. Specifically, for example, the range of the communication area of the radio base station, positioned in the periphery of the radio base station in which an error occurs, is adjusted in such a way that at least a part of the range (for example, a shape, a size, and the like) that is the communication area of the radio base station in which the error occurs is compensated for or maintained. The adjustment of the range of the communication area of the radio base station is achieved, for example, by controlling a tilt angle or the like of an antenna included in the radio base station. As a result, the mobile terminal, positioned within the range that is the communication area of the radio base station in which the error occurred, is positioned inside the range of the communication area of the radio base station in the periphery of the radio base station in which an error occurs. Due to this, the radio communication may be maintained.

The radio base station 20 covers the cell 29 (a so-called macrocell) of which the radius is approximately several kilometers to more than ten kilometers or several tens of kilometers. The radio base station 20 performs the radio communication with the mobile terminal 30 included in the radio base station 20 (that is, the mobile terminal 30 is positioned inside the cell covered by the radio base station 20). That is, the radio base station 20 establishes a communication connection with the mobile terminal 30 included in the radio base station 20 and transmits and receives data to and from the mobile terminal 30. FIG. 1 illustrates an example of a case where the radio base station 20a performs the radio communication with the mobile terminal 30a and the mobile terminal 30b, and the radio base station 20b performs the radio communication with the mobile terminal 30c and the mobile terminal 30d. The radio base station 20 performs the communication, through a wired communication line, with the monitor control station 10 positioned in an upper order of the radio base station 20.

The mobile terminal 30 establishes a communication connection with the radio base station 20 corresponding to the cell 29, in which the mobile terminal 30 is positioned, and transmits and receives the data. The mobile terminal 30 may use various services and applications (for example, a mail service, a speech communication service, a WEB browsing service, and the like) through the radio base station 20 (furthermore, a core network (not illustrated) positioned in an upper order of the monitor control station 10). A mobile phone, a Personal Digital Assistant (PDA), and various information apparatuses with radio communication functions are given as examples of the mobile terminal 30.

In the above description, the radio base station 20 covers the cell 29 (a so-called macrocell) of which the radius is approximately several kilometers to more than ten kilometers or several tens of kilometers. However, in addition to or instead of the radio base station 20, a radio base station that covers the cell (a so-called macrocell) of which the radius is approximately several hundred meters to one kilometer and a radio base station that covers the cell (a so-called femtocell) of which the radius is approximately several meters to more than ten meters may be used and/or allocated. Various radio base stations that cover the cell of which the radius does not have the above-described size may be used and/or allocated.

(2) Configuration of Monitor Control Station

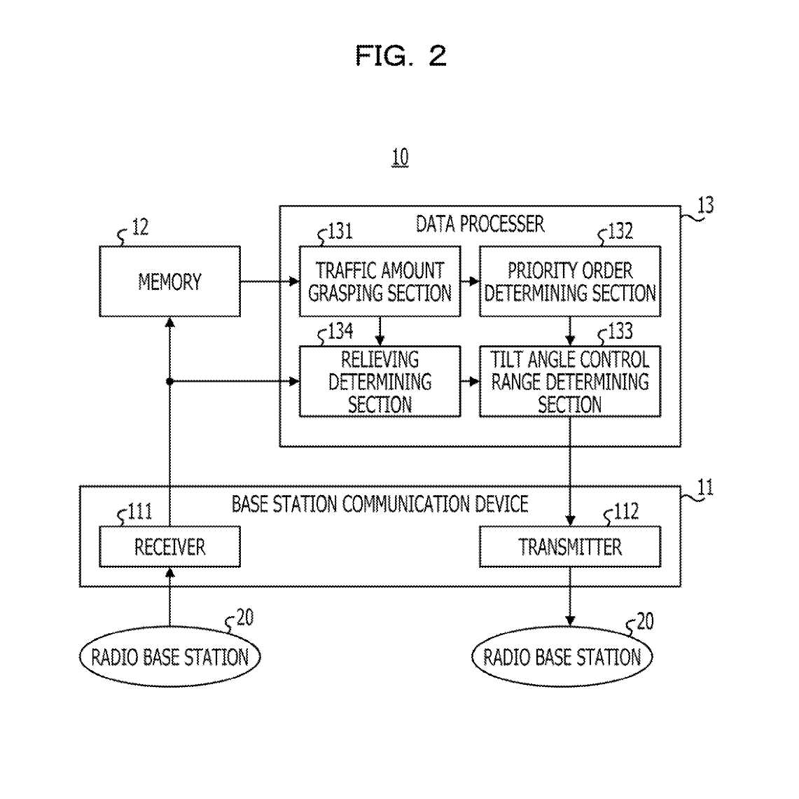

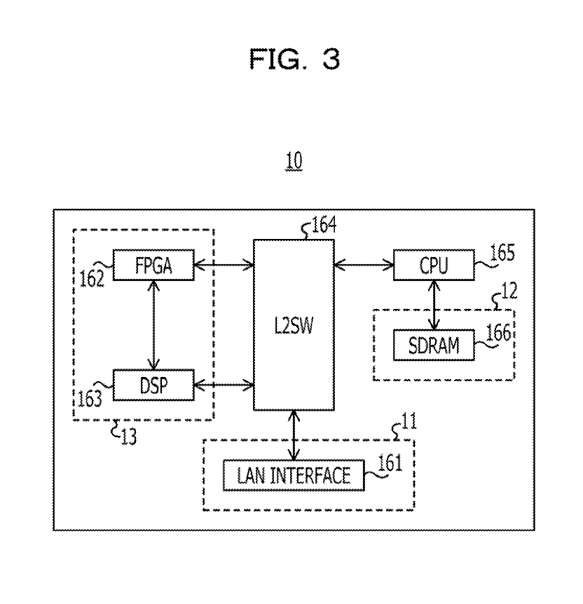

With reference to FIG. 2 and FIG. 3, a configuration of the monitor control station 10 according to the first embodiment will be described. FIG. 2 is a block diagram illustrating function blocks of the monitor control station 10. FIG. 3 is a block diagram illustrating an example of hardware blocks of the monitor control station 10.

As illustrated in FIG. 2, the monitor control station 10 includes a base station communication device 11, a memory 12, and a data processor 13.

The base station communication device 11 includes a receiver 111 that receives data transmitted from the radio base station 20, and a transmitter 112 that transmits the data to the radio base station 20.

The memory 12 stores traffic information such as a traffic amount of each of the plurality of radio base stations 20 positioned under the monitor control station 10. The traffic amount stored in the memory 12 is included, for example, in control data transmitted from each of the plurality of radio base stations 20 to the monitor control station 10. The number of the mobile terminals 30 included in each of the plurality of radio base stations 20, the data amount to be processed by each of the plurality of radio base stations 20, and the like are given as an example of the traffic amount.

The data processor 13, which is an example of a controller, controls operations of the monitor control station 10. The data processor 13 includes, for example, a traffic amount grasping section 131, a priority order determining section 132, a tilt angle control range determining section 133, and a relieving determining section 134 as a processing block that is logical or functional to be provided inside the data processor 13.

The traffic amount grasping section 131 obtains the traffic amount stored in the memory 12. For example, the traffic amount grasping section 131 obtains the traffic amount of the error base station 20 and of each of the plurality of peripheral base stations 20 if an error occurs in at least one of the plurality of radio base stations 20 positioned under the monitor control station 10. The traffic amount grasping section 131 outputs the obtained traffic amount of the error base station 20 to the relieving determining section 134. The traffic amount grasping section 131 outputs the obtained traffic amounts of the plurality of peripheral base stations 20 to the priority order determining section 132.

Based on the traffic amount of the plurality of peripheral base stations 20, the priority order determining section 132 determines the priority order for compensating the range that is the cell 29 of the error base station 20 with respect to each of the plurality of peripheral base stations 20. The priority order determining section 132 reports the determined priority order to the tilt angle control range determining section 133. In addition to or instead of determining the priority order of the peripheral base station 20, the priority order determining section 132 may determine the peripheral base station 20 that compensates the range that is the cell 29 of the error base station 20. In this case, the priority order determining section 132 may report the determined peripheral base station 20 to the tilt angle control range determining section 133.

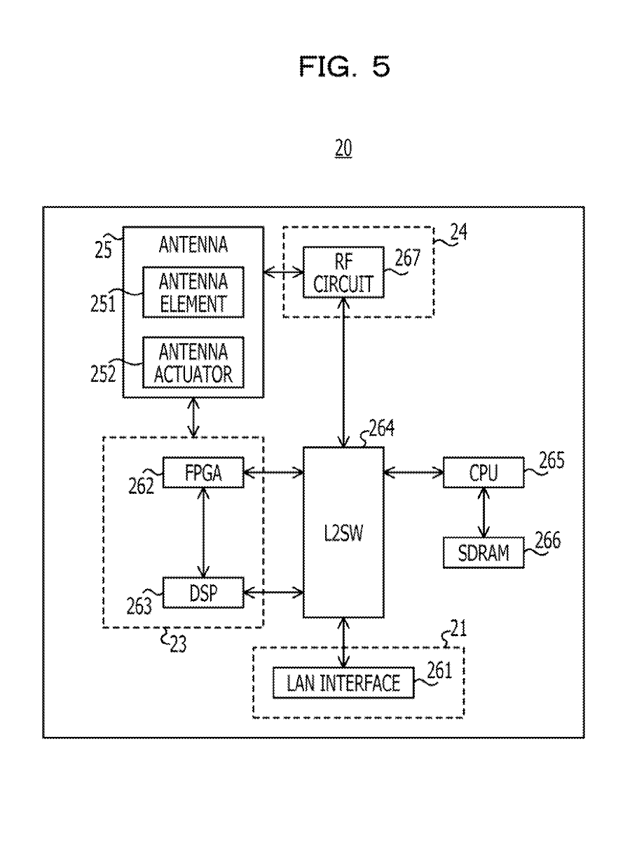

According to the priority order reported from the priority order determining section 132, the tilt angle control range determining section 133 determines the control range that controls the tilt angle of the antenna element 251 (see FIG. 5) included in each of the plurality of peripheral base stations 20. Alternatively, the tilt angle control range determining section 133 may determine the control range, reported from the priority order determining section 132, that controls the tilt angle of the antenna element 251 included in each of the peripheral base stations 20 (that is, the peripheral base stations 20 determined to compensate the range that is the cell 29 of the error base station 20). The tilt angle control range determining section 133 reports the determined control range of the tilt angle to the corresponding peripheral base station 20. The peripheral base station 20 to which the control range of the tilt angle is reported controls the tilt angle of the antenna element 251 by operating an antenna actuator 252 (see FIG. 5).

The relieving determining section 134 determines whether or not the determination standard for relieving the error base station 20 is satisfied by controlling the tilt angle of the antenna element 251 of the peripheral base station 20. A determination result is reported to, for example, the tilt angle control range determining section 133.

As illustrated in FIG. 3, the monitor control station 10 includes a LAN interface 161, a Field Programmable Gate Array (FPGA) 162, a Digital Signal Processor (DSP) 163, a Layer 2 Switch (L2SW) 164, a CPU 165, and an SDRAM 166. The LAN interface 161 controls the communication with the radio base station 20 through the LAN line coupled to the monitor control station 10. The FPGA 162 is an integrated processing circuit with a rewritable logic circuit and is defined or designed to perform processing according to the specification of the monitor control station 10. The DSP 163 performs various processing related to a digital signal. The L2SW 164 controls transmission of signals among the LAN interface 161, the FPGA 162, the DSP 163, and the CPU 165. The CPU 165, which is a control circuit operating based on prescribed firmware or the like, controls operations of the monitor control station 10. The SDRAM 166 temporally stores data to be used inside the monitor control station 10 and stores a program (e.g., firmware) to be executed to operate the monitor control station 10. The LAN interface 161 corresponds to the above-described base station communication device 11. The SDRAM 166 corresponds to the above-described memory 12. The FPGA 162 and the DSP 163 correspond to the above-described data processor 13.

(3) Configuration of Radio Base Station

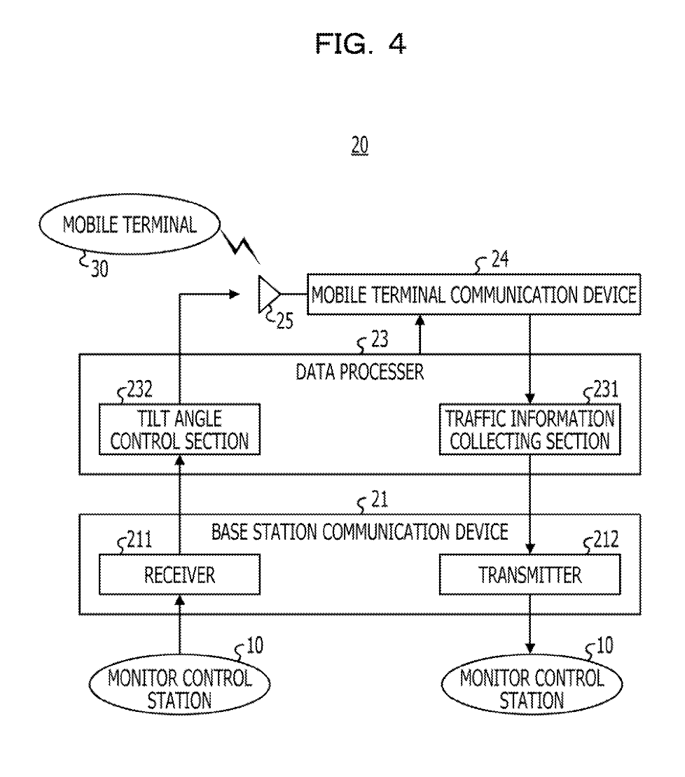

With reference to FIG. 4 and FIG. 5, a configuration of the radio base station 20 according to the first embodiment will be described. FIG. 4 is a block diagram illustrating function blocks of the radio base station 20. FIG. 5 is a block diagram illustrating an example of hardware blocks of the radio base station 20.

As illustrated in FIG. 4, the radio base station 20 includes a control station communication device 21, a data processor 23, a mobile terminal communication device 24, and an antenna 25.

The control station communication device 21 includes a receiver 211 that receives data transmitted from the monitor control station 10, and a transmitter 212 that transmits the data to the monitor control station 10.

The data processor 23 controls operations of the radio base station 20. The data processor 23 includes a traffic information collecting section 231 and a tilt angle control section 232 as a processing block, which is logical or functional, provided inside the data processor 23.

The traffic information collecting section 231 collects the traffic amount of the radio base station 20. The collected traffic amount is transmitted as a part of the control data, for example, to the monitor control station 10.

The tilt angle control section 232 operates the antenna actuator 252 according to the control range of the tilt angle transmitted from the monitor control section 10. As a result, for example, a motor or the like included in the antenna actuator 252 changes the tilt angle of the antenna element 251. Since the tilt angle is changed, the shape or the size of the radio base station 20 varies.

The mobile terminal communication device 24 receives the data (that is, an uplink signal) transmitted from the mobile terminal 30 and transmits the data (that is, a downlink signal) to the mobile terminal 30.

The antenna 25 outputs the radio signal (radio wave) according to the data, which is transmitted to the mobile terminal 30. The antenna 25 receives the radio signal output from the mobile terminal 30 (that is, the radio signal according to the data transmitted from the mobile terminal 30).

As illustrated in FIG. 5, from the viewpoint of the hardware configuration, the radio base station 20 includes a LAN interface 261, an FPGA 262, a DSP 263, an L2SW 264, a CPU 265, an SDRAM 266, a Radio Frequency (RF) circuit 267, and an antenna 25. The LAN interface 261 controls the communication with the monitor control station 10 through the LAN line coupled to the radio base station 20. The FPGA 262, which is an integrated processing circuit that includes a rewritable logic circuit, is defined or designed to perform processing according to the specification of the radio base station 20. The DSP 263 performs various processing related to the digital signal. The L2SW 264 controls transmission of signals among the LAN interface 261, the FPGA 262, the DSP 263, the CPU 265, and the RF circuit 267. The CPU 265, which is a control circuit operating based on prescribed firmware or the like, controls operations of the radio base station 20. The SDRAM 266 temporally stores the data to be used inside the radio base station 20 and stores a program (e.g., firmware) to be executed to operate the radio base station 20. The RF circuit 267 performs the radio transmitting/receiving processing (for example, amplifying processing or the like). The antenna 25 includes an antenna element 251 that emits radio waves, and the antenna actuator 252 that adjusts the tilt angle of the antenna element 251. The LAN interface 261 corresponds to the above-described control station communication device 21. The FPGA 262 and the DSP 263 correspond to the above-described data processor 23. The RF circuit 267 corresponds to the above-described mobile terminal communication device 24.

(4) Operation Example

With respect to FIG. 6, an operation example of the radio communication system 1 according to the first embodiment will be described. FIG. 6 is a flowchart illustrating a flow of the operation example of the radio communication system 1 according to the first embodiment.

As illustrated in FIG. 6, the data processor 13 included in the monitor control station 10 determines whether or not an error occurs in at least one of the plurality of radio base stations 20 under the monitor control station 10 (Operation S11). For example, the determination of error occurrence may be performed by referring to an alarm or a control message reported from the radio base station 20 to the monitor control station 10.

According to the determination result from Operation S11, if no error occurs (NO in Operation S119), the monitor control station 10 repeats Operation S11.

According to the determination result from Operation S11, if the error occurs (YES in Operation S119), the traffic amount grasping section 131 included in the monitor control station 10 obtains the traffic amount of the error base station 20 before the error occurs (Operation S12). The traffic amount grasping section 131 included in the monitor control station 10 obtains each traffic amount of the plurality of peripheral base stations 20 (Operation S13).

Based on each traffic amount of the plurality of peripheral base stations 20 obtained in Operation S13, the priority order determining section 132 included in the monitor control station 10 determines the priority order for compensating the range that is the cell 29 of the error base station 20 with respect to each of the plurality of peripheral base stations 20 (Operation S14). For example, the priority order determining section 132 may determine the priority order so that a higher priority order is assigned to the peripheral base station 20 having a lower traffic amount. That is, the priority order determining section 132 may determine the priority order so that the peripheral base station 20 having a larger traffic amount is assigned with a lower priority order. For example, the priority order determining section 132 may determine the priority order so that the peripheral base station 20 having a lower processing load is assigned with a higher priority order. That is, the priority order determining section 132 may determine the priority order so that a lower priority order is assigned to the peripheral base station 20 having a higher processing load.

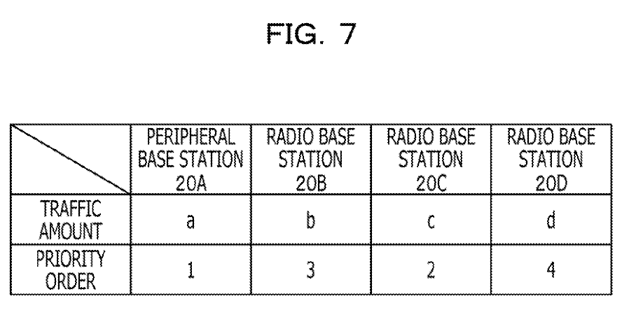

With reference to FIG. 7, an example of a determination operation of the priority order will be described. As illustrated in FIG. 7, the traffic amount of a peripheral base station 20A is “a.” The traffic amount of a peripheral base station 20B is “b.” The traffic amount of a peripheral base station 20C is “c.” The traffic amount of a peripheral base station 20D is “d.” In a case of a<c<b<d, the priority order determining section 132 determines that the priority order of the peripheral base station 20A having the lowest traffic amount is “1” that indicates the highest priority order. The priority order determining section 132 determines that the priority order of the peripheral base station 20C having the second lowest traffic amount is “2” that indicates the second highest priority order. The priority order determining section 132 determines that the priority order of the peripheral base station 20B having the third lowest traffic amount is “3” that indicates the third highest priority order. The priority order determining section 132 determines that the priority order of the peripheral base station 20D having the highest traffic amount is “4” that indicates the fourth highest priority order. The priority order illustrated in FIG. 7 may be stored as an internal parameter in the SDRAM 16 included in the monitor control station 10.

Based on the traffic amount of the peripheral base station 20, FIG. 6 and FIG. 7 illustrate an example of the priority order of the peripheral base station 20. However, the priority order determining section 132 may determine the priority order of the peripheral base station 20 based on an arbitrary parameter (for example, a CPU usage rate, a processing data amount, a delay time, an assignment state or usage state of a radio resource) directly or indirectly indicating the load of the peripheral base station 20 in addition to or instead of the traffic amount. In this case, the memory 12 included in the monitor control station 10 is preferable to store the arbitrary parameter, in addition to or instead of the traffic amount, that directly or indirectly indicates the load of the radio base station 20. The traffic amount grasping section 131 included in the monitor control station 10 is preferable to obtain the arbitrary parameter, in addition to or instead of the traffic amount, that directly or indirectly indicates the load of the radio base station 20. The traffic information collecting section 231 included in the radio base station 20 is preferably to collect the arbitrary parameter, in addition to or instead of the traffic amount, that directly or indirectly indicates the load of the radio base station 20.

In FIG. 6, according to the priority order reported from the priority order determining section 132, the tilt angle control range determining section 133 included in the monitor control station 10 determines the control range that controls the tilt angle of the antenna element 251, included in each of the plurality of peripheral base stations 20 (Operation S15). For example, the tilt angle control range determining section 133 may determine the control range of the tilt angle so that the peripheral base station 20 having a higher priority order determined in Operation 14 has a larger control range. That is, the tilt angle control range determining section 133 may determine the control range of the tilt angle so that the control range is smaller if the peripheral base station 20 has a lower priority order determined in Operation S14.

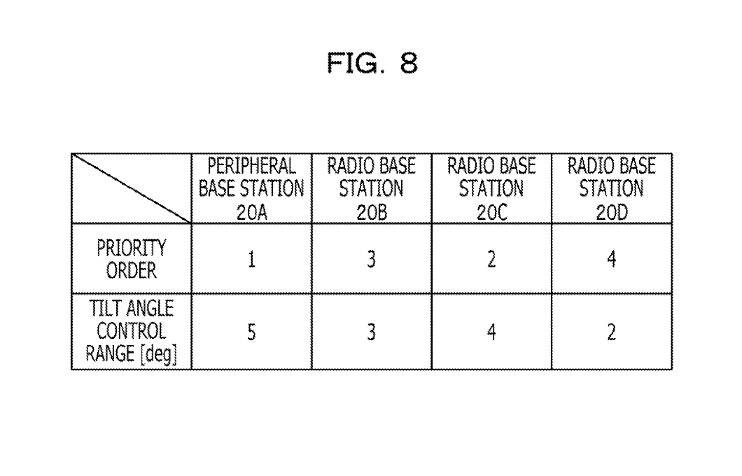

With reference to FIG. 8, an example of the determination operation of the control range of the tilt angle will be described. As illustrated in FIG. 8, the peripheral base station 20A has the highest priority order “1,” the peripheral base station 20C has the second highest priority order “2,” the peripheral base station 20B has the third highest priority order “3,” and the peripheral base station 20D has the fourth highest priority order “4.” The tilt angle control range determining section 133 determines that the control range of the tilt angle of the peripheral base station 20A having the highest priority order is the largest range “5 deg.” The tilt angle control range determining section 133 determines that the control range of the tilt angle of the peripheral base station 20C having the second highest priority order is the second largest range “4 deg.” The tilt angle control range determining section 133 determines that the control range of the tilt angle of the peripheral base station 20B having the third highest priority order is the third largest range “3 deg.” The tilt angle control range determining section 133 determines that the control range of the tilt angle of the peripheral base station 20D having the lowest priority order is the smallest range “2 deg.” The control range of the tilt angle illustrated in FIG. 8 may be stored as an internal parameter inside the SDRAM 166 included in the monitor control station 10.

The tilt angle control range determining section 133 may determine the control range of the tilt angle so that the peripheral base station 20 having a higher priority order determined in Operation S14 covers a larger part or range of the cell 29 of the error base station 20. Alternatively, for example, the tilt angle control range determining section 133 may determine the control range of the tilt angle so that the peripheral base station 20 having a higher priority order determined in Operation S14 relieves more mobile terminals 30 that are stored (or were stored) in the error base station 20.

As illustrated in FIG. 6, the tilt angle control range determining section 133 reports the control range of the tilt angle determined in Operation S15 to the corresponding peripheral base station 20 in an order according to the priority order. Specifically, the tilt angle control range determining section 133 reports the control range of the tilt angle corresponding to the peripheral base station 20 having the highest priority order to the peripheral base station 20 having the highest priority order (Operation S16). The control range of the tilt angle reported from the tilt angle control range determining section 133 is obtained by the tilt angle control section 232 included in the peripheral base station 20 having the highest priority order. The tilt angle control section 232 controls the tilt angle of the antenna element 251 by operating the antenna actuator 252 according to the reported control range of the tilt angle (Operation S16). Since the tilt angle is controlled, the shape or size of the cell 29 of the peripheral base station 20 varies. As a result, the cell 29 of the peripheral base station 20 compensates (covers) at least a part of the cell 29 of the error base station 20.

Every time the tilt angle of the antenna element 251 included in one of the peripheral base stations 20 is controlled, the relieving determining section 134 determines whether or not the determination standard for relieving the error base station 20 is satisfied (Operation S17). For example, the relieving determining section 134 may determine whether or not a prescribed amount (for example, 90% of the traffic amount) of the traffic amount before the error occurrence in the error base station 20 is relieved. Alternatively, the relieving determining section 134 may determine whether or not a prescribed amount (for example, 90% of the mobile terminal 30) of the mobile terminal 30 stored in the error base station 20 is relieved. The traffic amount (that is, the mobile terminal 30) may be determined to be relieved or not by referring to position information (for example, GPS information) indicating the position of the mobile terminal 30 reported from the mobile terminal 30. If the position information indicating the position of the error base station 20 inside the cell 29 is reported from the mobile terminal 30 to the peripheral base station 20, the mobile terminal 30 is determined to be stored (that is, relieved) in the peripheral base station 20 by controlling the tilt angle. On the other hand, for example, if the position information indicating the position of the error base station 20 inside the cell 29 is not reported from the mobile terminal 30 to the peripheral base station 20, the mobile terminal 30 is determined not to be stored (that is, relieved) in the peripheral base station 20 by controlling the tilt angle. Since the determination is performed based on the position information, preferably the peripheral base station 20 reports the reception result of the position information from the mobile terminal 30 to the monitor control station 10. By referring to the reception result reported from the peripheral base station 20 and comparing a relieving state indicated by the reception result to the traffic amount of the error base station 20, the relieving determining section 134 may determine whether or not the determination standard of relieving is satisfied.

According to the result of the determination in Operation S17, if the determination standard for relieving is satisfied (YES in Operation S17), the monitor control station 10 preferably does not control the tilt angle corresponding to another peripheral base station 20 while maintaining the ongoing control of the tilt angle. For example, as illustrated in the example in FIG. 8, if the determination standard for relieving is satisfied when the tilt angle with respect to the peripheral base station 20A having the highest priority order is controlled, the monitor control station 10 preferably does not control the tilt angle with respect to each of the peripheral base stations 20B, 20C and 20D while maintaining the control of the tilt angle with respect to the peripheral base station 20A.

On the other hand, based on the determination result from Operation S17, if the determination standard for relieving is not satisfied (NO in Operation S17), the tilt angle control range determining section 133 determines whether or not the tilt angle with respect to all the peripheral base stations 20 is controlled (Operation S18). For example, as illustrated in FIG. 8, the tilt angle control range determining section 133 determines whether or not the tilt angle with respect to all the peripheral base stations 20A to 20D is controlled.

Based on the determination result from Operation S18, if the tilt angle with respect to all the peripheral base stations 20 is controlled (YES in Operation S18), the monitor control station 10 ends the operation. In this case, the monitor control station 10 may maintain or stop the ongoing control of the tilt angle (that is, the original state may return). If the determination standard for relieving is not satisfied when the tilt angle is performed with respect to the controlled peripheral base station 20, the error base station 20 is assumed not to be relieved. Therefore, the monitor control station 10 may report, to an operator of the error base station 20, that the peripheral base station 20 may not relieve the error base station 20.

Based on the determination result from Operation S18, if the tilt angle with respect to all of the peripheral base stations 20 is not controlled (NO in Operation S18), the tilt angle control range determining section 133 reports the control range of the tilt angle with respect to the peripheral base station 20 having the second highest priority order to the peripheral base station 20 having the second highest priority order (Operation S19). The control range of the tilt angle reported from the tilt angle control range determining section 133 is obtained by the tilt angle control section 232 included in the peripheral base station 20 having the second highest priority order. The tilt angle control section 232 controls the tilt angle of the antenna element 251 by operating the antenna actuator 252 according to the reported control range of the tilt angle (Operation S19).

The relieving determining section 134 determines whether or not the determination standard for relieving the error base station 20 is satisfied (Operation S17). A similar operation is repeated until the determination standard for relieving the error base station 20 is satisfied or until the control of the tilt angle with respect to all the peripheral base stations 20 is controlled.

According to the radio communication system 1 of the first embodiment, the range that is the cell 29 of the error base station 20 may be compensated in consideration of the traffic amount of the peripheral base station 20. According to the radio communication system 1 of the first embodiment, compared to the radio communication system that compensates the range that is the cell 29 of the error base station 20 without consideration of the traffic amount of the peripheral base station 20, the range that is the cell 29 of the error base station 20 may preferably be compensated. That is, the error base station 20 may be preferably relieved.

Here, as compared with the radio communication system 1 of the first embodiment, an example of a radio communication system relating to conventional techniques is described. In the example of the radio communication system, the radio base station that compensates the range that is the communication area of the radio base station in which the error occurs is specified in advance by being set by, for example, an operator of the radio base station. In this case, the technical problem described below may occur according to the operation state of the radio base station that is specified in advance. Specifically, for example, the radio base station, which compensates the range that is the communication area of the radio base station in which the error occurs, processes not simply the traffic to be processed before compensating the range that is the communication area of the radio base station in which the error occurs but also the new traffic to be added after compensating the range that is the communication area of the radio base station in which the error occurs. Accordingly, if the traffic amount processed before the radio base station on the compensating side compensates the range is relatively large, the traffic amount to be proceeded after being compensated by the radio base station may exceed the acceptable value. In this case, the radio communication of the mobile terminal positioned in the cell of the radio base station on the compensating side may be interrupted. The above-described technical problem may occur when the load of the radio base station is relatively large regardless of the traffic amount of the radio base station. Furthermore, the above-described technical problem may occur not simply when the range that is the communication area of the radio base station in which the error occurs is compensated, but also when another radio base station compensates the communication area (or the range that is the communication area) of a specific radio base station.

In contrast, according to the radio communication system 1 of the first embodiment, the range that is the cell 29 of the error base station 20 may preferably be compensated. That is, the error base station 20 may preferably be relieved.

According to the radio communication system 1 of the first embodiment, the peripheral base station having a lower traffic amount may compensate a larger part of the range that is the cell 29 of the error base station 20. Therefore, for example, exceeding the acceptable value of the traffic amount of the peripheral base station 20 due to the compensating may be suppressed.

According to the radio communication system 1 of the first embodiment, the tilt angle may be controlled in the descending order from the peripheral base station 20 having a small traffic amount. For example, the occurrence of exceeding of the acceptable value of the traffic amount of the peripheral base station 20 is preferably suppressed when the peripheral base station 20 having a large traffic amount first compensates the range that is the cell 29 of the error base station 20.

According to the radio communication system 1 of the first embodiment, the tilt angle with respect to the peripheral base station 20 may be controlled with reference to the traffic amount before the error occurrence in the error base station 20. Therefore, the tilt angle with respect to the peripheral base station 20 may be controlled so that the traffic amount before the error occurrence in the error base station 20 may be properly compensated.

According to the radio communication system 1 of the first embodiment, every time the tilt angle with respect to one of the peripheral base stations 20 is controlled, determination may be made to indicate whether or not the determination standard for relieving is satisfied. If the determination standard for relieving is not satisfied, the tilt angle with respect to the peripheral base station 20 having the second highest priority order is controlled. Therefore, the tilt angle of an excessively large number of the peripheral base stations 20 being controlled is unlikely.

According to the radio communication system 1 of the first embodiment, the priority order may be added to each of the plurality of peripheral base stations 20. Therefore, with reference to the added priority order, the control range of the tilt angle may be easily determined in a proper order, and the tilt angle may be controlled.

According to the first embodiment, the control of the tilt angle of the antenna element 251 included in the radio base station 20 is given as an example of a control method for compensating the range that is the cell 29 of the error base station 20. However, the range that is the cell 29 of the error base station 20 may be compensated by using a method other than the control of the tilt angle of the antenna element 251. For example, the tilt angle control range determining section 133 included in the monitor control station 10, and the tilt angle control section 232 and the antenna actuator 252 or the like included in the radio base station 20 may be changed according to a different employed method (that is, the method other than the control of the tilt angle). For example, the range that is the cell 29 of the error base station 20 may be compensated by controlling a parameter that affects beam forming of a radio wave emitted from the antenna element 251. For example, the range that is the cell 29 of the error base station 20 may be compensated by controlling the transmission power of the peripheral base station 20. Alternatively, the range that is the cell 29 of the error base station 20 may be compensated by controlling a reception power threshold value at handover to the peripheral base station 20.

The first embodiment describes an example of a case where the cell 29 of the error base station 20 in which the error occurs is compensated. However, when the peripheral base station 20 compensates the cell 29 of the radio base station 20 in which the error does not occur but the error may occur in the future, the configuration and operations of the above-described embodiments may be employed. Alternatively, to compensate the cell 29 of the radio base station 20 that is specific, desired, or arbitrary by the peripheral base station 20 regardless of the error occurrence, the configurations and operations of the above-described embodiments may be employed. In the above-described configuration, the above-described various effects may be achieved.

(5) Modified Operation

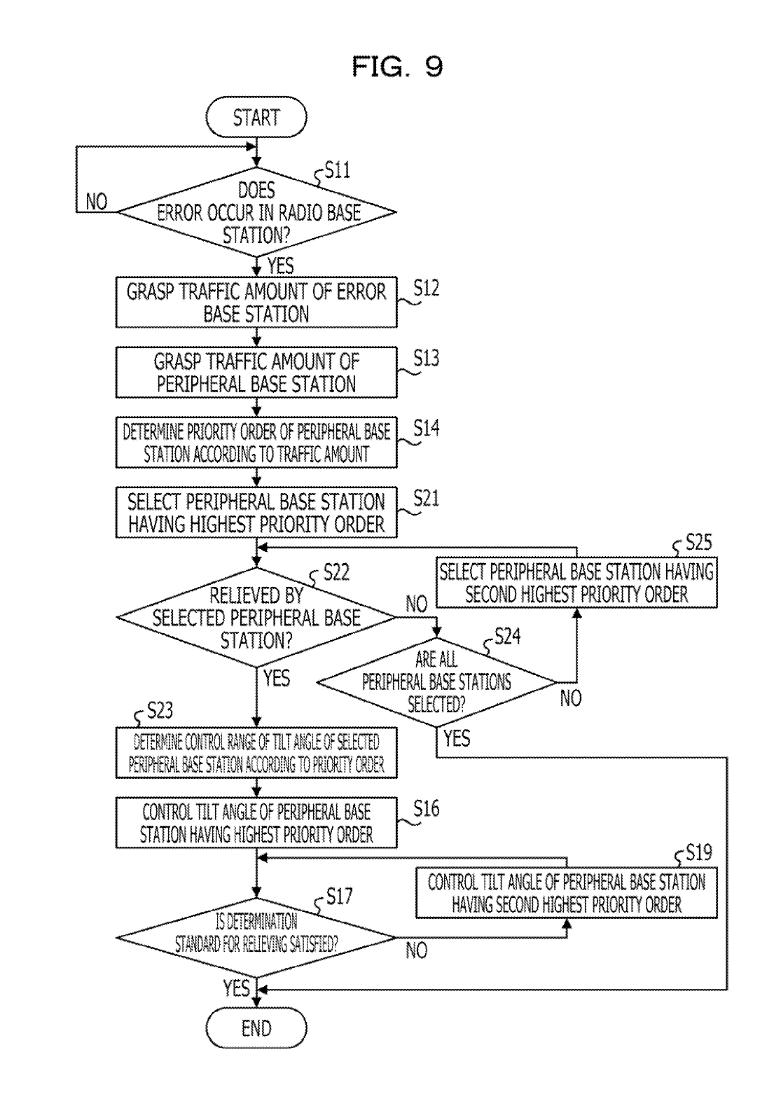

With reference to FIG. 9, a modified operation according to the radio communication system 1 of the first embodiment will be described below. FIG. 9 is a flowchart illustrating a flow of the modified operation according to the radio communication system 1 of the first embodiment. The operation equivalent to the operation illustrated in FIG. 6 is indicated by the numerals equivalent to FIG. 6, so the detailed description of those operation will be omitted.

As illustrated in FIG. 9, the data processor 13 included in the monitor control station 10 determines whether or not an error occurs in at least one of the plurality of radio base stations 20 under the monitor control station 10 (Operation S11).

Based on the determination result from Operation S11, if no error occurs (NO in Operation S11), the monitor control station 10 repeats Operation S11.

Based on the determination result from Operation S11, if an error occurs (YES in Operation S11), the traffic amount grasping section 131 included in the monitor control station 10 obtains the traffic amount of the error base station 20 before the error occurrence (Operation S12). Furthermore, the traffic amount grasping section 131 included in the monitor control station 10 obtains each traffic amount of the plurality of peripheral base stations 20 (Operation S13).

Based on each traffic amount of the plurality of peripheral base stations 20 obtained in Operation S13, the priority order determining section 132 included in the monitor control station 10 determines the priority order to compensate the range that is the cell 29 of the error base station 20 with respect to each of the plurality of peripheral base stations 20 (Operation S14).

In the modified operation example, the relieving determining section 134 selects the peripheral base station 20, which has the highest priority order, as a candidate that compensates the range that is the cell 29 of the error base station 20 (Operation S21). The relieving determining section 134 predicts whether or not the error base station 20 is relieved when all the peripheral base stations 20 that have been selected compensate the range that is the cell 29 of the error base station 20 (Operation S22). The relieving determining section 134 may predict whether or not the error base station 20 is relieved based on the empty traffic amount (that is, the traffic amount that may further be stored) of the peripheral base station 20 and the traffic amount before the error occurrence in the error base station 20. For example, the relieving determining section 134 may calculate the empty traffic amount of the peripheral base station 20 by referring to the traffic amount of the peripheral base station 20. The relieving determining section 134 may determine whether or not the total empty traffic amount of the selected peripheral base station 20 exceeds a prescribed amount (for example, 90% of the traffic amount) of the traffic amount of the error base station 20 before the error occurrence. If the total empty traffic amount of the selected peripheral base station 20 exceeds the prescribed amount of the traffic amount of the error base station 20 before the error occurrence in the error base station 20, the error base station 20 is predicted to be relieved. On the other hand, if the total empty traffic amount of the selected peripheral base station 20 does not exceed the prescribed amount of the traffic amount before the error occurrence in the error base station 20, the error base station 20 is predicted not to be relieved.

Based on the determination result from Operation S21, if the error base station 20 is predicted not to be relieved (NO in Operation S22), the relieving determining section 134 determines whether or not all the peripheral base stations 20 are selected as a candidate that compensates the range that is the cell 29 of the error base station 20 (Operation S24).

Based on the determination result from Operation S24, if all the peripheral base stations 20 are selected as a candidate that compensates the range that is the cell 29 of the error base station 20 (YES in Operation S24), the monitor control station 10 ends the operation. That is, the monitor control station 10 ends the operation without controlling the tilt angle with respect to the peripheral base station 20. The monitor control station 10 may report that the peripheral base station 20 may not relieve the error base station 20 to the operator of the error base station 20.

On the other hand, based on the determination result from Operation S24, if the all the peripheral base stations 20 are not selected as a candidate that compensates the range that is the cell 29 of the error base station 20 (NO in Operation S24), the relieving determining section 134 selects the peripheral base station 20 having the second highest priority order as a candidate that compensates the range that is the cell 29 of the error base station 20 (Operation S25). The relieving determining section 134 determines whether or not the error base station 20 may be relieved if all the selected peripheral base stations 20 compensate the range that is the cell 29 of the error base station 20 (Operation S22). The similar operation is repeated until the error base station 20 is determined to be relieved or until all the peripheral base stations 20 are selected.

On the other hand, based on the determination result from Operation S21, if the error base station 20 is predicted to be relieved (YES in Operation S22), the tilt angle control range determining section 133 determines the control range, which controls the tilt angle of the antenna element 251 included in each of the peripheral base stations 20 selected in Operation S21 and Operation S25, according to the priority order reported from the priority order determining section 132 (YES in Operation S22). The method for determining the control range of the tilt angle in Operation S22 may be equivalent to the method for determining the control range of the tilt angle in Operation S15 illustrated in FIG. 6.

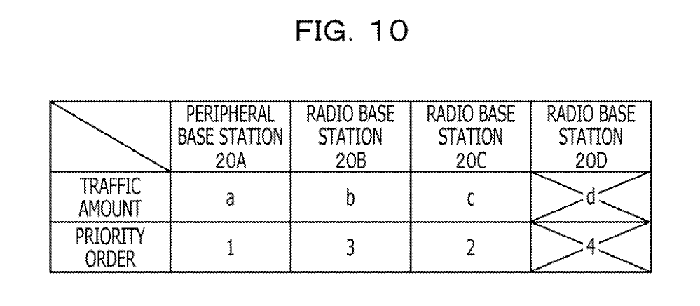

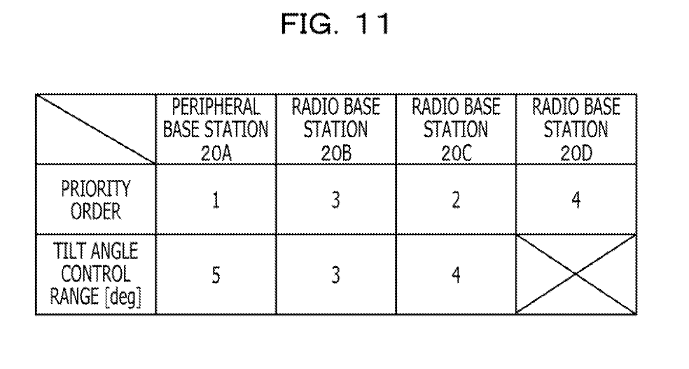

With reference to FIG. 10 and FIG. 11, an example of the determination operation of the control range of the tilt angle will be described. As illustrated in FIG. 10, it is assumed that the error base station 20 is predicted to be relieved when the peripheral base station 20A having the highest priority order, the peripheral base station 20C having the second highest priority order, and the peripheral base station 20B having the third highest priority order are selected. In this case, as illustrated in FIG. 11, the tilt angle control range determining section 133 may determine the control range of the tilt angle with respect to the peripheral base station 20A having the highest priority order, the peripheral base station 20C having the second highest order, and the peripheral base station 20B having the third highest priority order, respectively. On the other hand, as illustrated in FIG. 11, the tilt angle control range determining section 133 may be unlikely to determine the control range of the tilt angle with respect to the peripheral base station 20D that is not selected.

In FIG. 9, the tilt angle control range determining section 133 reports, to the peripheral base station 20 having the highest priority order, the control range of the tilt angle corresponding to the peripheral base station 20 having the highest priority order (Operation S16). The control range of the tilt angle reported from the tilt angle control range determining section 133 is obtained by the tilt angle control section 232 included in the peripheral base station 20 having the highest priority order. The tilt angle control section 232 controls the tilt angle of the antenna element 251 by operating the antenna actuator 252 according to the reported control range of the tilt angle (Operation S16).

The relieving determining section 134 determines whether or not the determination standard for relieving the error base station 20 is satisfied (Operation S17) when the tilt angle of the antenna element 251 included in one of the peripheral base stations 20 is adjusted or controlled.

Based on the determination result from Operation S17, if the determination standard for relieving the error base station 20 is satisfied (YES in Operation S17), the monitor control station 10 does not control the tilt angle with respect to another peripheral base station 20 while maintaining the ongoing control of the tilt angle.

On the other hand, based on the determination result from Operation S17, if the determination standard for relieving the error base station 20 is not satisfied (NO in Operation S17), the tilt angle control range determining section 133 reports the control range of the tilt angle corresponding to the peripheral base station 20 having the second highest priority order to the peripheral base station 20 having the second highest priority order (Operation S19). The relieving determining section 134 determines whether or not the determination standard for relieving the error base station 20 is satisfied (Operation S17). A similar operation is repeated until the determination standard for relieving the error base station 20 is satisfied or until the tilt angle with respect to all the peripheral base stations 20 is controlled.

In the modified operation, if the error base station 20 is predicted to be relieved by the peripheral base station 20, the tilt angle with respect to the peripheral base station 20 is actually controlled. Accordingly, there is rarely a state where the determination standard for relieving is not satisfied when the tilt angle with respect to all the peripheral base stations 20 is controlled. In the modified operation, the determination operation in Operation S18 illustrated in FIG. 6 may be unlikely to be performed. The determination operation in Operation S18 illustrated in FIG. 6 may be performed.

As described above, according to the modified operation, the above-described various effects may be achieved. In addition, according to the modified operation, if the error base station 20 is predicted to be relieved by the peripheral base station 20, the tilt angle is actually controlled. Therefore, if the error base station 20 is not predicted to be relieved by the peripheral base station 20, the tilt angle may be unlikely to be actually controlled. Therefore, the processing load related to the control of the tilt angle by the monitor control station 10 and the peripheral base station 20 may be relatively reduced. According to the above-described radio communication system, the peripheral base station that varies the communication area may be determined in consideration of the load of the peripheral base station.

All examples and conditional language recited herein are intended for pedagogical purposes to aid the reader in understanding the invention and the concepts contributed by the inventor to furthering the art, and are to be construed as being without limitation to such specifically recited examples and conditions. Although the embodiments have been described in detail, it should be understood that the various changes, substitutions, and alterations could be made hereto without departing from the spirit and scope of the invention.

What is claimed is:

1. A radio communication system comprising:
a plurality of radio base stations; and
a control station which controls the plurality of radio base stations, wherein
the control station comprises a controller which determines a peripheral base station, from among a plurality of peripheral base stations, and which adjusts a radio parameter for changing a range of a communication area based on each load of the plurality of peripheral base stations which are adjacent or close to a radio base station to be relieved from among the plurality of radio base stations.

2. The radio communication system according to claim 1, wherein the controller controls generation of a piece of information to be used to adjust the radio parameter and to report the information to the peripheral base station in such a way that the peripheral base station having a smaller load, from among the plurality peripheral base stations, compensates a larger part of the range which is a communication area of the radio base station to be relieved.

3. The radio communication system according to claim 2, wherein the controller controls generation of the information to be used to adjust the radio parameter and to report the information to the peripheral base station in such a way that the determined peripheral base station compensates the range that is the communication area of the radio base station to be relieved in an ascending order of the load of the determined peripheral base station until a prescribed amount of the load of the radio base station to be relieved is compensated.

4. The radio communication system according to claim 2, wherein if one of the determined peripheral base stations does not compensate the prescribed amount of the load of the radio base station to be relieved, the controller controls generation of the information to be used to adjust the radio parameter of another peripheral base station and to report the information to the other peripheral base in such a way that the other peripheral base station compensates the range which is the communication area of the radio base station to be relieved, and
wherein if the one of the determined peripheral base stations compensates the prescribed amount of the load of the radio base station to be relieved, the controller does not generate the information to be used to adjust the radio parameter of the other peripheral base station or to report the information to the other peripheral base station.

5. The radio communication system according to claim 2, wherein before determining the peripheral base station that adjusts the radio parameter, the controller selects a candidate base station as a candidate radio base station which adjusts the radio parameter from among the plurality of peripheral base stations,
wherein when the candidate base station compensates the range which is the communication area of the radio base station to be relieved, the controller predicts whether the candidate base station compensates a prescribed amount of the load of the radio base station to be relieved,
wherein the controller determines that the candidate base station is the peripheral base station if the candidate base station is predicted to compensate the prescribed amount of the load of the radio base station to be relieved, and
wherein the controller does not determine the peripheral base station which adjusts the radio parameter or to report the information to be used to adjust the radio parameter to the peripheral base station if the candidate base station is not predicted to compensate the prescribed amount of the load of the radio base station to be relieved.

6. The radio communication system according to claim 2, wherein the controller controls the plurality of peripheral base stations in such a way that a higher priority order is added to the peripheral base station having a smaller load and a lower priority order is added to the peripheral base station having a larger load, and that the peripheral base station compensates the range which is the communication area of the radio base station to be relieved in the ascending order of the priority order of the peripheral base station.

7. The radio communication system according to claim 1, wherein the controller controls the plurality of peripheral base stations, in such a way that the range which is the communication area of the radio base station to be relieved, so that an acceptable value of the load of the peripheral base station is not exceeded.

8. The radio communication system according to claim 1, wherein the radio base station comprises:
an obtaining section which obtains a piece of information to be used to adjust the radio parameter reported from the control station; and
an adjusting section which adjusts the radio parameter of the radio base station based on the information to be used to adjust the radio parameter obtained by the obtaining section.

9. A control station comprising:
a controller which controls a plurality of radio base stations, wherein the controller determines a peripheral base station based on a load of each of a plurality of peripheral base stations which is adjacent or close to the radio base station to be relieved, and adjusts a radio parameter for changing a range of a communication area based on each load of the plurality of peripheral base stations.

10. A control method comprising:
controlling a plurality of radio base stations;
determining a peripheral base station, which adjusts a radio parameter for changing a range of a communication area, from among a plurality of peripheral base stations, the determining being based on a load of each of the plurality of peripheral base stations which is adjacent or close to a radio base station to be relieved; and
reporting information to be used to adjust the radio parameter to the determined peripheral base station.

11. The control method according to claim 10, comprising:
generating the information to be used to adjust the radio parameter in such a way that a peripheral base station having a smaller load, from among the determined peripheral base stations, compensates a larger part of the range which is the communication area of the radio base station to be relieved; and
reporting the information to the peripheral base station.

12. The control method according to claim 11, comprising:
generating the information to be used to adjust the radio parameter and reporting the information to the peripheral base station in such a way that the determined peripheral base station compensates the range which is the communication area of the radio base station to be relieved in an ascending order of the load of the peripheral base station until a prescribed amount of the load of the radio base station to be relieved is compensated.

13. The control method according to claim 11, further comprising:
if one of the determined peripheral base stations does not compensate the prescribed amount of the load of the radio base station to be relieved, generating the information to be used to adjust the radio parameter of the other peripheral base station and reporting the information to the peripheral base station in such a way that the peripheral base station having a load which is the second smallest, next to the load of the one of the peripheral base stations; and
if the one of the peripheral base stations compensates the prescribed amount of the load of the radio base station to be relieved, not performing generation of the information to be used to adjust the radio parameter of the other peripheral base station and reporting the information to the other peripheral base station.

14. The control method according to claim 11, further comprising:
before the peripheral base station which adjusts the radio parameter is determined, selecting a candidate base station as a candidate radio base station which adjusts the radio parameter of the plurality of peripheral base stations;
if the candidate base station compensates the range which is the communication area of the radio base station to be relieved, predicting whether a prescribed amount of the load of the radio base station to be relieved,
if the load of the peripheral base station to be relieved is predicted to be compensated, determining that the candidate base station is the peripheral base station, and
wherein if the prescribed amount of the load of the radio base station to be relieved is predicted not to be compensated, the determining does not determine the peripheral base station which adjusts the radio parameter and the reporting does not report the information to be used to adjust the radio parameter with respect to the determined peripheral base station.

15. The control method according to claim 10, further comprising:
adding a higher priority order to a smaller load of the peripheral base stations and adding a lower priority order to a larger load of the plurality of peripheral base stations, respectively, and
compensating the range which is the communication area of the radio base station to be relieved in an ascending order of the priority order from among the plurality of peripheral base stations.

16. The control method according to claim 10, wherein the plurality of peripheral base stations is controlled, in such a way that the range which is the communication area of the radio base station to be relieved, so that an acceptable value of the load of the peripheral base station is not exceeded.

17. The control method according to claim 10, wherein the radio base station obtains the information to be used to adjust the radio parameter reported from the control station and adjusts the radio parameter of the radio base station based on the obtained information to be used to adjust the radio parameter.
